(19) United States
(12) Patent Application Publication
(10) Pub. No.: US 2018/0139115 A1
(43) Pub. Date: May 17, 2018

(54) REMOTE MAINTENANCE SYSTEM HAVING A MOBILE REMOTE MAINTENANCE UNIT, AND CONFIGURATION METHOD

(71) Applicant: Mario SCHWAIGER, Reutte (AT)

(72) Inventor: Mario SCHWAIGER, Reutte (AT)

(21) Appl. No.: 15/566,057

(22) PCT Filed: Apr. 13, 2016
(86) PCT No.: PCT/AT2016/050094

§ 371 Date: Jan. 30, 2018

(30) Foreign Application Priority Data
Apr. 13, 2015 (AT) A 50291/2015

(51) Int. Cl. H04L 12/26; G06F 21/62

(52) U.S. Cl. CPC H04L 43/0823; G06F 21/62

(57) ABSTRACT

The invention relates to a remote monitoring system (1) comprising a technical device (2) to be maintained or operated, a mobile remote maintenance unit (3), a communications network (4) and at least one communications remote station (5). The remote maintenance unit (3) is a computer system (18) designed for mobile operation and, among other things, has a sensor interface (8), a communications interface (9) and a human-machine interface (15). A data connection (10) between the communications interface (9) of the remote maintenance unit (3) and the communications remote station (5) exists via the communications network (4). A contactlessly readable data memory (11) is provided on the technical device (2) to be maintained, in which configuration data (12) of the communications interface (9) and configuration data (13) of the communications remote station (5) are stored. Further, the mobile remote maintenance unit (3) has a reading means (14) for reading out the data memory (11). The invention further relates to a configuration method of a mobile remote maintenance unit (3) in a remote maintenance system (1).

The invention relates to a remote maintenance system having a mobile maintenance unit and to a method for configuring a mobile maintenance unit in a remote maintenance system.

In industrial premises, machine tools or production machines, assembly lines and the like, initial commissioning of the plant is carried out in order for it to then be put into undisturbed and mostly uninterrupted operation for as long as possible. In the event of a fault with an individual unit, it is then particularly important for a skilled technician to get to the place of deployment as quickly as possible in order to be able to carry out the appropriate maintenance work. Particularly in the field of manufacturing systems or production lines, a failure or shutdown of a component immediately means a mostly not inconsiderable economic loss, wherein the magnitude of the loss is sometimes measured in one-minute intervals. Service agreements, in which in most cases a very short response time is agreed, are therefore concluded between the operator of such a plant and the supplier or manufacturer of system-critical components. Agreements of this kind have the disadvantage that they are mostly very expensive and a shutdown or failure of the component still occurs until the external service technician is on site.

Remote maintenance systems, with which an external technician connects to a system or a component on the premises and carries out maintenance or service work, are known. However, for this, it is necessary that the component concerned can still accept the external connection; further, the component must be fundamentally designed for this, in other words there is a fundamental possibility of remote maintenance. This has the disadvantage, however, that an external service technician must have a multiplicity of different access variations available in order to be able to access a multiplicity of supplied components. An important disadvantage is also that only those actions which were foreseen during the original production or commissioning of the component can be carried out in the course of such a maintenance operation. If the affected component can no longer be accessed for remote maintenance, or if actions which were not foreseen during the original production have to be carried out, such an attempt at remote maintenance will fail.

Remote maintenance solutions, in which a local technician is connected to an external technician by means of a communications system, in most cases a telephone and, possibly, a video cable, are also known. Compared with the previously mentioned systems, this embodiment has the advantage that the external technician can communicate with someone on site and has therefore considerably more handling options. Because of the limitations due to the communications option and the effort of establishing a communications connection between the local service technician and the external specialist, a lot of time for solving the existing problems is lost. With these embodiments, in most cases considerable effort is also required to establish and set up the remote maintenance solution.

It would now be of advantage if remote maintenance were possible at all times and independent of the original configuration of the component and, further, manual control operations could also be carried out without an external specialist having to go to the location of the component concerned for this purpose. Further, remote maintenance must be able to be carried out by a technician with a general technical understanding; in particular, an elaborate establishment or elaborate configuration of a remote maintenance system must not be required.

The object of the invention now consists in creating a system for the remote maintenance of a component, with which rapid intervention of an external specialist at the location of the component concerned is possible and, further, the disadvantages of known remote maintenance systems are overcome. Further, a way must be provided for a local service technician to be able to collaborate interactively with an external specialist.

The object of the invention is achieved by a remote monitoring system which comprises a technical device to be maintained or operated, a mobile remote maintenance unit, a communications network and at least one communications remote station. The remote maintenance unit comprises a computer system designed for mobile operation and therefore has at least one main processor, volatile and non-volatile storage means, a sensor interface and a communications interface. Further, the mobile remote maintenance unit has a human-machine interface. A data connection between the communications interface of the remote maintenance unit and the communications remote station exists via the communications network. A contactlessly readable data memory is provided on the technical device to be maintained, wherein configuration data of the communications network and configuration data of the communications interface are stored in the data memory. Further, the mobile remote maintenance unit has a reading means for reading out the data memory.

Here, maintenance is understood to mean any action which includes or necessitates intervention and/or access to the technical device. In particular, for example, in order to gather data which help an external expert to solve an existing problem or an existing requirement on site. An adjustment or parameterization operation is also understood as maintenance.

A mobile computer system is specially designed for the requirement of mobile deployment, in particular for a long period of use without external power supply. The human-machine interface will therefore have a reduced functional scope compared with a workplace system, for example a smaller display possibly combined with an on-screen keyboard. The computer system will also be limited with regard to its universal applicability due to the specialization on the task to be carried out.

Sensor interface is understood to mean a connection, which, preferably provided multiple times, is designed for connecting a plurality of different sensor systems. For example, the following can be understood as sensor systems: optical and thermographic camera systems, endoscopy systems, and sensors for measuring physical quantities. In particular, the sensor interface in question is designed in such a way that a connected sensor system is automatically detected and the appropriate access module is loaded into the computer system in order to carry out its assigned function without further assistance by the operator.

Storing is understood to mean that the configuration data are available in the data memory in a machine-readable form. Constitution of the configuration data in a human-readable design is unnecessary, and possibly also undesirable for data protection reasons.

A development consists in that the data memory is designed as optically readable 2D code. Non-exclusive examples of this are QR and DataMatrix codes. Codes of this kind enable a data memory to be formed with a storage capacity, which, although limited, is however adequate for the configuration data to be stored. The advantage of such codes lies in that, due to the standardization and wide distribution, a large number of ways of creating the codes are available. Detection means and, in particular, a multiplicity of libraries for extracting the coded content, are also available. The stored quantity of data can also be matched to the required scope by deviating from standardized designs.

A development also consists in that the data memory is designed as a wirelessly readable code element. Likewise non-exclusive examples of this are NFC and RFID-based tags. In areas of application in which contamination is to be expected, wirelessly readable data memories have the advantage that contamination does not restrict or does not substantially restrict the usability of the data memory.

According to a development, it is provided that the data connection is designed as a packet network connection. Packet-oriented data connections are very widely established, so that the probability is very high that some kind of technical implementation of a packet network connection is available at the place of deployment. In particular, a packet network connection is understood to mean any data connection which is based on the IP (Internet Protocol) standard, preferably on the TCP/IP standard. This guarantees that the remote maintenance unit will find a communications network at the place of deployment and will be able to establish a data connection. Non-exclusive examples of this are data connections which can be established via cabled and wireless communications networks such as LAN (Ethernet), WLAN, GPRS, etc.

According to a development, it is provided that the mobile remote maintenance unit is connected to an audio-visual input-output device carried by the operator of the remote maintenance unit. This embodiment has the advantage that, using this, the operator has his hands free for maintenance activities. Preferably, the device is designed as a so-called headset, which has the advantage that the audio-visual input-output device follows the operator's head movement and therefore his line of vision.

A development also consists in that the audio-visual input-output device has an image capturing and/or an audio capturing and/or an audio output device. These embodiments have the advantage that, in the case of an image capturing device, the communications remote station receives a live image from the place of deployment. In the case of the embodiment with an audio capturing and/or an audio output device, there is additionally the option of unidirectional or bidirectional audio transmission, in particular speech communication.

A development also consists in that, furthermore, the audio-visual input-output device has an image output device. According to a preferred embodiment of the audio-visual input-output device as a headset, this development can consist in that a semi-transparent projection screen or a prism is arranged in the field of view of the eye of the operator, on which screen or prism information from the image output device is displayed to the wearer of the headset without substantially impairing the field of view of the wearer. Along with a semi-transparent projection screen, it can also be provided that a display device is arranged in a lateral area outside the main viewing direction in order not to impair the operator's view. Non-exclusively, this display device can be an LC display, a TFT display or similar, for example.

Of advantage is a development, according to which the reading means is formed by the image capturing device. On the one hand, this achieves a very compact design and, on the other, an embodiment in the form of a headset guarantees that the reading means is always directed towards the working area.

A development also consists in that the reading means is formed by a high-frequency transmitting and receiving device, thus enabling data memories which have a high-frequency-based communications interface, such as NFC or RFID tags, to be read out.

According to a development, it is further provided that the configuration data are designed for exclusively one-off use. In the event of maintenance, the remote maintenance device may have to connect to the customer's data network, and data for accessing the company network may have to be disclosed by the customer. On completion of maintenance, the configuration data stored in the remote maintenance device leave the company and could possibly be misused by third parties. With the embodiment in question, it can now be guaranteed that, even in the event that configuration data get into the wrong hands, they cannot be misused as they become invalid after a single use. When the service technician finishes the maintenance work and dismantles the data connection, the configuration data lose their validity. This is achieved, for example, in that access data with one-off validity are generated by the customer and stored in the data memory.

In the following, the simplified sole mention of configuration data is in all cases intended to mean the configuration data of the communications remote station as well as the configuration data of the communications interface.

A development, according to which time-related and/or operator-related range information is stored in the configuration data, goes in a similar direction. With this development, for example, it can be achieved that access to the customer's (internal) communications network is only possible in a pre-defined time interval and/or by a definable user. It can therefore likewise be guaranteed that the company's own network cannot be compromised by a maintenance action.

According to a development, the configuration data of the communications interface are designed as at least one of the group comprising network identifier, user name, password, network parameters and VPN parameters.

As, according to further embodiments, standardized data memories which can be read by a multiplicity of available readers are used, it is provided that the configuration data stored in the data memory are encrypted in order to increase the protection of the stored configuration data.

A development consists in that the configuration data are encrypted with a public key of a public-key key pair, wherein the private key is stored in the computer system of the mobile remote maintenance unit, in particular in the non-volatile storage means or in a storage means which can be connected to the computer system. This enables the public key to be transmitted to the operator of the device to be maintained, who uses this to encrypt the configuration data and store it in the data memory. Storing the private key in the non-volatile storage means guarantees, for example by access limitations to the remote storage device, that the service technician is unable to access the configuration data, which in most cases is available in the remote maintenance device in encrypted form. Protection of the data for accessing the customer's network is therefore also guaranteed with this development. A connectable storage means could be designed, for example, as a so-called dongle, which is connected to the remote maintenance device as required in order to decrypt the configuration data.

A development also consists in that a protocol memory is connected to the remote maintenance unit, wherein the connection is possibly formed by the communications network. In terms of traceability of the maintenance work carried out, it is of advantage if the set actions are also available for later evaluation. A protocol memory according to the claims can, for example, be formed by a so-called network memory, which is addressed via the communications network. The access data for this can also be stored in the data memory in order, when reading out, to configure the communications interface or the remote maintenance unit with the effect of establishing a connection to the protocol memory. In a development, the protocol memory can also be formed by an email address or an email postbox.

According to a development, it is further provided that a contactlessly writable protocol memory is arranged at the technical device to be maintained or operated. This can be designed as an NFC or RFID tag, for example; it is also possible that the protocol memory is formed by the data memory or configured therein.

The object of the invention is also achieved by a configuration method of a mobile remote maintenance unit in a remote maintenance system, which configuration method includes the following steps. The reading means of the mobile remote maintenance unit is aligned by the operator with the data memory and activated, whereupon the configuration data are read out of the data memory. The communications interface of the mobile remote maintenance unit is configured with the configuration data read therefrom. A read-out data record of the configuration data of the communications remote station is displayed at the human-machine interface, and the data record of the communications remote station is selected by the operator at the human-machine interface. The communications interface of the mobile remote maintenance unit is then configured with the configuration data of the selected communications remote station, and a data connection is established between the communications interface of the mobile remote maintenance unit and the communications remote station. Audio and/or visual information packets are then transmitted between the communications remote station and the remote maintenance unit, in particular including the display and/or recording of the transmitted information packets at the human-machine interface.

The activation of the reading means does not necessarily have to be initiated by the operator, but can also take place in an automated manner in an initialization process. For example, it can be provided that, after switching on the device, the reading means is automatically activated and searches for a readable data memory, wherein the search time can be limited. If, as a result of the alignment of the device, a data memory is found, this is read and the further method steps are carried out. It can also be provided that, after switching on the device, this switches to a search mode and only switches to full operation after reading a data memory.

The configuration is carried out substantially by the main processor, in particular the execution units of the main processor, as is known from a computer system, even a specifically designed computer system equipped with a limited functional scope.

A development consists in that, on completion of the remote maintenance, the data connection is dismantled and the configuration data are deleted from the remote maintenance unit. This ensures that the data for accessing the company's internal communications network cannot leave the company.

A development, according to which access by the operator to the configuration data stored in the remote maintenance unit is made impossible by means of access restrictions, also goes in this direction. Access limitation can, for example, be realized by interrogating an operator identity, wherein the main processor checks whether the operator identity and a password are correct and whether this operator is allowed access to these communications data.

With a development, according to which, in the alignment step, the remote maintenance unit is moved by the operator into the vicinity of the data memory, it can be guaranteed that reading out the configuration is only possible when the remote maintenance unit is in the vicinity of the data memory. For example, this is achieved in that the size of the code elements of an optical 2D code is selected such that, at a larger distance, the resolution of the reading means is not sufficient to read out the configuration data. In the case of wireless-based data memories, this can be achieved by the design of the transmission and/or receiving characteristic. In this way, unauthorized reading from a distance can be prevented.

In order to ensure that use cannot be made of configuration data that have been read out without authority, according to a development, it is provided that the read-out configuration data are decrypted with the private key stored in the storage means of the remote maintenance unit.

In order to prevent unauthorized operation of the remote maintenance unit, according to a development, it is provided that, at least before establishing the data connection, an authentication of the operator of the remote maintenance unit is carried out. Preferably, this authentication is carried out by means of an input mask at the human-machine interface. It is however also possible that the operator has also assigned a data record which must also be read out by the reading means in order to enable full operation of the remote maintenance unit.

The operator's data record can also be designed to be read out optically or wirelessly, thus enabling the reading means to be used for this purpose without modification.

In order to be able to associate the executed maintenance steps with an operator, according to a development, it is provided that an identification of the authenticated user is stored in the protocol memory. For later analysis and checking, it is therefore easily possible to identify the operator concerned in order to discuss the steps carried out.

Likewise for later checking and reconstruction, according to a development, it is provided that at least some of the transmitted audio and/or visual information packets are stored in the protocol memory. In this way, a 1:1 reconstruction of the steps carried out is possible, which can be important, particularly in the case of warranty queries.

According to a development, it is further provided that sensor and/or actuator data are transmitted via the data connection. For example, it can be important for the external specialist at the communications remote station to be able to directly access data from sensors connected to the sensor interface, or to be able to control a device connected to the remote maintenance unit from a distance, for example align a camera by means of PTZ commands.

For better understanding of the invention, it is described in more detail with reference to the following figures.

In the drawings, in each case in greatly simplified schematic form:

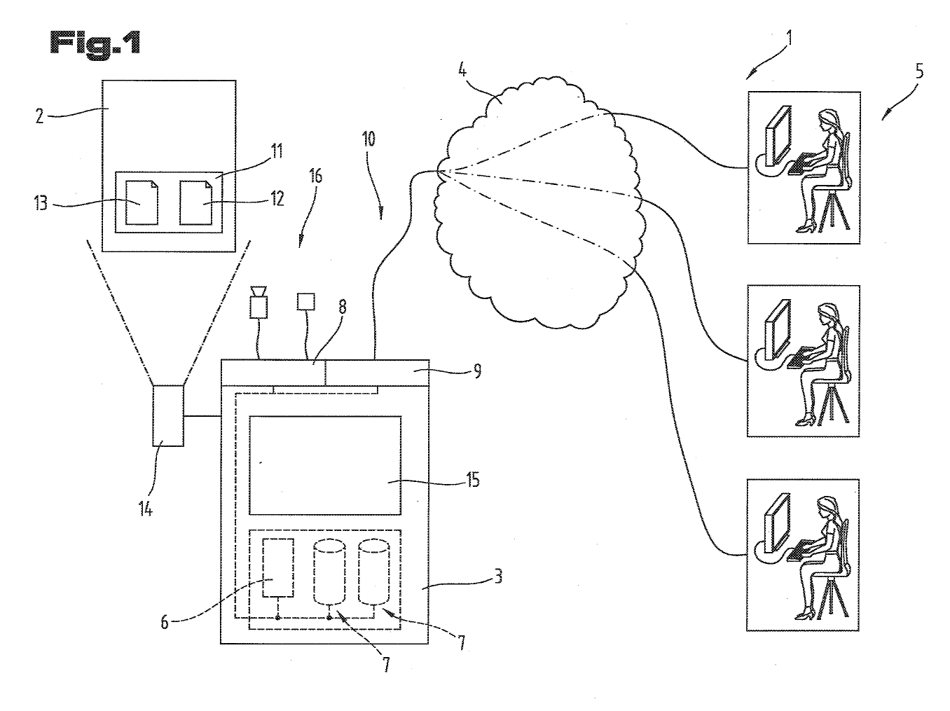

FIG. 1 shows the remote maintenance system in question;

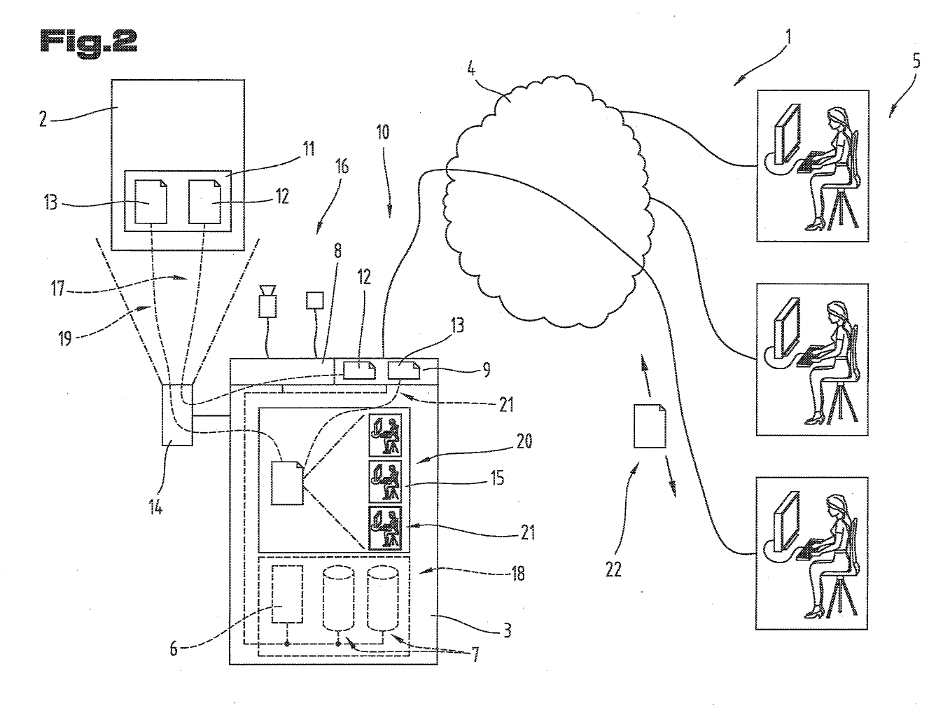

FIG. 2 shows the basic steps for configuring the remote maintenance unit in question.

FIG. 1 shows the remote monitoring system 1 in question, comprising a technical device 2 to be maintained or operated, a mobile remote maintenance unit 3, a communications network 4 and at least one communications remote station 5. The remote maintenance unit 3 has at least one main processor 6 as well as volatile and non-volatile storage means 7. Further, the remote maintenance unit 3 has a sensor interface 8 and a communications interface 9. Between the communications interface 9 of the remote maintenance unit 3 and the communications interface 5 is a data connection 10. A contactlessly readable data memory 11 is provided on the technical device 2 to be maintained, in which data memory 11 configuration data 12 of the communications interface 9 and configuration data 13 of the communications remote station 5 are stored. The remote maintenance unit 3 has a reading means 14 for reading out the configuration data 12, 13. For interaction with the operator, the remote maintenance unit 3 also has a human-machine interface 15 which is preferably formed by a screen, in particular by a contact-sensitive screen. A plurality of sensors 16 can be connected to the sensor interface 8, which sensors can be designed, for example, for recording physical quantities and/or be optical sensors, for example thermographic or endoscopic cameras.

The communications network can be designed as any packet-oriented communications network which supports the Internet protocol (IP, preferably TCP/IP). A multiplicity of different wireless and cabled communications networks or communications media can therefore be used, so that with very great probability it can be assumed that a communications network of this kind will be available at the maintenance location and the remote maintenance unit will connect to the communications network and be able to establish a data connection.

The communications remote station 5 will in most cases be a computer system which is operated by a specialist and preferably has full access to all resources of the manufacturer of the component to be maintained. Because of the data connection 10 which has been established, the location at which the communications remote station 5 is situated is of no importance, so that the main advantage for the manufacturer of the component is that the specialists for the system to be maintained can be based centrally or in the vicinity of the manufacturer and, in spite of this, the response time for the customer is very fast.

FIG. 2 shows schematically a process sequence of the method in question for configuring a mobile remote monitoring unit 3 in a remote monitoring system 1 in question. In a first step 17, the reading means 14 is brought by the operator of the remote maintenance unit 3 into the vicinity of the technical device 2, in particular into the vicinity of the data memory 11, and, after activating the reading means 14, the data memory 11, in particular the configuration data 12 of the communications interface 9, is/are read out. The instructions contained in the configuration data 12 are decoded by the computer system 18, and the communications interface 9 is then parameterized with the appropriate parameters for accessing the communications network 4. In this way, a data connection can be established to the communications network 4, for example in order to be able to access Internet resources.

The configuration data 13 of the communications remote station 5 can also be read out at the same time as reading out the configuration data 12 of the communications interface in the first step 17, wherein this is also possible in a subsequent second step 19. These configuration data 13 are also decoded and analyzed by the computer system 18 and a data record 20 therefrom displayed on the human-machine interface 15.

In a third step 21, one of the displayed data records 20 is selected by the operator, whereupon the communications interface 9 is configured by the computer system 18 with the selected data record 20, and a data connection 10 between the communications interface 9, and therefore the remote maintenance unit 3, and the selected communications remote station 5 is established thereby.

The remote maintenance then begins and audio and/or visual information packets 22, and possibly data packets with sensor, actuator and control data, are exchanged between the remote maintenance unit 3 and the communications remote station 5.

On completion of the remote maintenance session, the configuration data 12, 13 are deleted from the communications interface 9, thus guaranteeing that security-related access data do not leave the company of the operator of the technical device 2.

The particular advantage of the configuration method in question or the remote maintenance system in question now lies in that an operator with basic technical knowledge is in a position to carry out maintenance on a technical device 2, as the operator is supported by an external specialist at an external communications remote station 5, connected to the remote maintenance unit 3. For the external specialist at the communications remote station 5 the advantage consists in that he has full access, also physical access, to the technical device 2 to be maintained without having to be on site in person. For the operator of the plant or the technical device 2, there is the particular advantage that the response time to rectify a fault or to carry out maintenance of the technical device is very short. Furthermore, it is of advantage that the operator of the remote maintenance unit 3 does not have to bother with parameterization or the establishment of the data connection 10, as this occurs automatically and without his assistance by reading out and incorporating stored configuration data. For the operator of the plant, there is a further advantage that sensitive access data to an internal company communications network do not have to be disclosed and, if necessary, it can be ensured that these access data are not able to leave the industrial premises of the technical device.

In conclusion, it should be noted that identical parts in the different embodiments described are assigned the same references or the same component designations, wherein the disclosures contained in the overall description can be conferred analogously on identical parts with the same references or same component designations. The positional information chosen in the description, such as, for example, top, bottom, side, etc., relates to the figure directly described and shown, and in the event of a positional change, this positional information is to be conferred analogously on the new position.

The exemplary embodiments show possible design variants of the remote maintenance system and of the configuration method, wherein at this point it should be noted that the invention is not restricted to the specially shown design variants thereof, but rather various combinations of the individual design variants with one another are also possible and, based on the teaching relating to the technical activity due to the present invention, this variation option lies within the ability of the person skilled in the art in this technical field.

Furthermore, individual characteristics or combinations of characteristics from the different exemplary embodiments shown and described can also constitute independent, inventive solutions or solutions according to the invention in their own right.

The object on which the independent inventive solutions are based can be seen from the description.

All particulars of value ranges in the present description are to be understood such that they include any and all sub-ranges thereof, e.g., the information 1 to 10 is to be understood such that all sub-ranges, starting from the lower limit 1 and the upper limit 10 are included, i.e., all sub-ranges beginning with a lower limit of 1 or greater and ending at an upper limit of 10 or less, e.g., 1 to 1.7, or 3.2 to 8.1, or 5.5 to 10.

Above all, the individual embodiments shown in the figures can form the subject matter of independent solutions according to the invention. The related objects and solutions according to the invention can be found in the detailed descriptions of these figures.

Finally, as a matter of form, it should be pointed out that, for better understanding of the design of the remote maintenance system and of the configuration method, these or their constituent parts have to some extent been shown not-to-scale and/or enlarged and/or reduced.

### LIST OF REFERENCES

1 Remote monitoring system
2 Technical device
3 Remote maintenance unit
4 Communications network
5 Communications remote station
6 Main processor
7 Storage means
8 Sensor interface
9 Communications interface
10 Data connection
11 Data memory
12 Communications interface configuration data
13 Communications remote station configuration data
14 Reading means
15 Human-machine interface
16 Sensors
17 First step
18 Computer system
19 Second step
20 Data record
21 Third step
22 Information packets

1-25. (canceled)

26. A remote monitoring system (1) comprising
a technical device (2) to be maintained or operated,
a mobile remote maintenance unit (3),
a communications network (4), and
at least one communications remote station (5),
wherein the remote maintenance unit (3) comprises a computer system (18) designed for mobile operation and at least one main processor (6), volatile and non-volatile storage means (7), a sensor interface (8) and a communications interface (9), and
wherein, further, the mobile remote maintenance unit (3) has a human-machine interface (15), and
wherein a data connection (10) between the communications interface (9) of the remote maintenance unit (3) and the communications remote station (5) exists via the communications network (4), and
wherein a contactlessly readable data memory (11) is provided on the technical device (2) to be maintained, and
wherein the mobile remote maintenance unit (3) has a reading means (14) for reading out the data memory (11),
wherein configuration data (12) of the communications interface (9) and configuration data (13) of the communications remote station (5) are stored in the data memory (11), and
wherein the configuration data of the communications interface (9) are designed as at least one of the group comprising network identifier, user name, password, network parameters and VPN parameters.

27. The remote maintenance system according to claim 26, wherein the data memory (11) is designed as optically readable 2D code.

28. The remote maintenance system according to claim 26, wherein the data memory (11) is designed as a wirelessly readable code element.

29. The remote maintenance system according to claim 26, wherein the data connection (10) is designed as a packet network connection.

30. The remote maintenance system according to claim 26, wherein the mobile maintenance unit (3) is connected to an audio-visual input-output device carried by the operator of the remote maintenance unit (3).

31. The remote maintenance system according to claim 30, wherein the audio-visual input-output device has an image capturing and/or an audio capturing and/or an audio output device.

32. The remote maintenance system according to claim 30, wherein, furthermore, the audio-visual input-output device has an image output device.

33. The remote maintenance system according to claim 30, wherein the reading means (14) is formed by the image capturing device.

34. The remote maintenance system according to claim 28, wherein the reading means (14) is formed by a high-frequency transmitting and receiving device.

35. The remote maintenance system according to claim 26, wherein the configuration data are designed for exclusively one-off use.

36. The remote maintenance system according to claim 26, wherein time-related and/or operator-related range information is stored in the configuration data.

37. The remote maintenance system according to claim 26, wherein the configuration data stored in the data memory (11) are encrypted.

38. The remote maintenance system according to claim 37, wherein the configuration data are encrypted with a public key of a public-key key pair, wherein the private key is stored in the computer system (18) of the mobile remote maintenance unit (3), in particular in the non-volatile storage means (7) or in a storage means which can be connected to the computer system (18).

39. The remote maintenance system according to claim 26, wherein a protocol memory is connected to the remote maintenance unit (3), wherein the connection is possibly formed by the communications network (4).

40. The remote maintenance system according to claim 26, wherein a contactlessly writable protocol memory is arranged at the technical device (2) to be maintained or operated.

41. A configuration method of a mobile remote maintenance unit (3) in a remote maintenance system (1) according to claim 26, comprising the following steps:
Alignment of the reading means (14) of the mobile remote maintenance unit (3) with the data memory (11) by the operator and activation of the reading means (14);
Reading of the configuration data from the data memory (11);
Configuration of the communications interface (9) of the mobile remote maintenance unit (3) with the read-out configuration data of the data connection (10);
Display of a data record (20) of the configuration data of the communications remote station (5) at the human-machine interface (15);
Selection of the data record (20) of the communications remote station (5) at the human-machine interface (15) by the operator;
Configuration of the communications interface (9) of the mobile remote maintenance unit (3) with the configuration data of the selected communications remote station (5);
Establishment of the data connection (10) between the communications interface (9) of the mobile remote maintenance unit (3) and the communications remote station (5); and
Transmission of audio and/or visual information packets (22) between the communications remote station (5) and the remote maintenance unit (3), in particular display and/or recording at the human-machine interface.

42. The configuration method according to claim 41, wherein, on completion of the remote maintenance, the data connection (10) is dismantled and the configuration data are deleted from the remote maintenance unit (3).

43. The configuration method according to claim 41, wherein access by the operator to the configuration data stored in the remote maintenance unit (3) is made impossible by means of access restrictions.

44. The configuration method according to claim 41, wherein, in the alignment step, the remote maintenance unit (3) is moved by the operator into the vicinity of the data memory (11).

45. The configuration method according to claim 41, wherein the read-out configuration data are decrypted with the private key stored in the storage means (7) of the remote maintenance unit (3).

46. The configuration method according to claim 41, wherein, at least before establishing the data connection (10), an authentication of the operator of the remote maintenance unit (3) is carried out.

47. The configuration method according to claim 46, wherein an identification of the authenticated user is stored in the protocol memory.

48. The configuration method according to claim 41, wherein at least some of the transmitted audio and/or visual information packets (22) are stored in the protocol memory.

49. The configuration method according to claim 41, wherein sensor and/or actuator data are transmitted via the data connection (10).
